(19) United States
(12) Patent Application Publication
(10) Pub. No.: US 2026/0149234 A1
(43) Pub. Date: May 28, 2026

(54) Intracavity Frequency-Doubling Yellow Laser Device

(71) Applicant: Fuzhou Photop Optics Co., Ltd., Fuzhou (CN)

(72) Inventors: Yanli Wang, Fuzhou (CN); Jian Ding, Fuzhou (CN); Yi Huang, Fuzhou (CN); Hao Tan, Fuzhou (CN); Zhe Liu, Fuzhou (CN); Xu Jia, Fuzhou (CN); Guanglong Yu, Fuzhou (CN); Lei Lin, Fuzhou (CN)

(73) Assignee: Fuzhou Photop Optics Co., Ltd., Fuzhou (CN)

(21) Appl. No.: 19/014,330

(22) Filed: Jan. 9, 2025

(30) Foreign Application Priority Data
Nov. 26, 2024 (CN) CN2024117064485

(51) Int. Cl. H01S 3/109; G02F 1/355; G02F 1/37; H01S 3/06; H01S 3/08; H01S 3/16

(52) U.S. Cl. CPC H01S 3/109; G02F 1/3553; G02F 1/37; H01S 3/0621; H01S 3/08054; H01S 3/08059; H01S 3/1611; H01S 3/1643

(57) ABSTRACT

An intracavity frequency-doubling laser device includes a first mirror and a second mirror defining a resonance cavity, a gain media to produce a first lasing light in response to an external pump beam received from outside the cavity, a nonlinear frequency-doubling optical element to generate a second lasing light in response to the first lasing light, a birefringent waveplate to control phase properties of the first and second lasing lights, and a fused quartz element positioned at the exit of the resonance cavity. The second mirror is formed as a relatively thick film on the fused quartz and is controlled to create an output beam of the second lasing light with great accuracy. The four components within the resonance cavity are positioned back-to-back and held in place using an optical glue (forming a compact, miniaturized laser device).

### TECHNICAL FIELD

The present disclosure relates to laser technologies, in particular to intracavity frequency-doubling laser devices operating at a wavelength of about 561 nm (i.e., a “yellow” wavelength within a visible portion of the spectrum).

### BACKGROUND

In many applications of lasers, it is desirable to have a stable laser with low cost, small size (i.e., compact) and low power consumption. In contrast, the configurations currently used to provide a yellow laser (that is, a laser device emitting at a wavelength of 561 nm) utilizes a discrete cavity structure, with a discrete birefringent filter positioned in the cavity, resulting in a relatively large-volume component with a high power consumption. As well, these devise require complex processing and are relatively expensive to fabricate.

Presently, there are two conventional methods of obtaining a laser capable of emitting at 561 nm (hereinafter referred to as a “yellow laser”); namely, directly using a periodically-poled lithium niobate (PPLN) nonlinear element as a frequency-doubling element for light radiating at 1122 nm to achieve the desired 561 nm value, or using a combination of an Nd:YAG laser with a lens and a birefringence filter to achieve the 561 nm output. Both approaches have their known drawbacks.

First, using PPLN frequency doubling to directly achieve 561 nm involves the use of a distributed feedback (DFB) laser operating at 1122 nm, which in itself is an expensive discrete device; the PPLN component only adding to this cost. Moreover, the PPLN is extremely sensitive to changes in ambient temperature, which thus requires additional temperature controlling components to be used as well.

Turning to the use of a combination of an Nd:YAG laser with a birefringence filter, the ability to control the coatings applied to the terminations (mirrors) defining the cavity, in terms of the wavelengths passed or reflected by the coatings and the related percentages, are not exact. It has been found difficult to achieve the necessary thicknesses and properties required to achieve the desired single-wavelength yellow light output.

### SUMMARY OF THE DISCLOSURE

The disclosed laser device relates to an intra-cavity frequency-doubling laser device configured for single wavelength operation as a visible “yellow” laser at a wavelength of 561 nm (preferably ±1 nm or less). Low noise and high polarization are achieved by inserting a wave plate into the resonance cavity. A special design is used to achieve frequency doubling light of a propagating 1122 nm beam to achieve a laser output of 561 nm. The resonance cavity includes a gain medium component (e.g., Nd:YAG material), a nonlinear optical element (e.g., a potassium titanyl phosphate (KTP) crystal), a birefringent waveplate, and a fused quartz element, the combination disposed between a first (i.e., front cavity) mirror and a second (i.e., rear cavity) mirror.

The gain medium component (Nd:YAG) and the nonlinear optical element (KTP) may be defined as a “first pair” of neighboring components, with the birefringent waveplate and the fused quartz element defined as a “second pair” of neighboring components, with each pair of neighboring components in contact with one another. The sequential grouping of the four components may be held together by utilizing an appropriate bonding material (referred to at times as “optical glue”) that does not impact the optical properties of the components (i.e., transparent to the wavelengths of interest). An advantage of directly gluing the four components together is that an extremely compact, miniaturized laser structure may be formed. For example, a laser having dimensions of 1 mm×1 mm may be formed using this compact, joined arrangement of these four components. As will be discussed below, the gain medium and nonlinear optical element may exchange positions within their first pair arrangement, while the positions of the waveplate and fused quartz element need to remain unchanged.

The front cavity (first) mirror may also be referred to as an input coupler for the laser device structure, and the rear cavity (second) mirror may also be referred to as an output coupler for the laser device structure.

The fused quartz element is positioned as the last element within the resonance cavity (i.e., adjacent to the rear cavity mirror) and indeed its exposed endface is used to define the rear cavity mirror; that is, the specific filter coatings used to achieve radiation emission of only the desired 561 nm single wavelength are applied directly to the quartz material itself. The thickness of the fused quartz element may be controlled to provide a resonant cavity of a proper length.

In all embodiments, the birefringent waveplate is positioned adjacent to the fused quartz element. In some configurations, the gain element is positioned first in the resonance cavity (i.e., adjacent to the front cavity mirror), followed by the nonlinear optical element that is used as the frequency doubling component. In other configurations, the nonlinear optical element (frequency doubling component) is positioned first, followed by the gain material element. Regardless of the ordering of the gain element and nonlinear element, the filter coatings used to form the front cavity mirror are applied to the exposed (outward-facing) endface of the first-positioned element. The birefringent waveplate is selected to function as a quarter waveplate for the fundamental frequency of the propagating laser light and a full-wave plate for the frequency-doubled beam. The waveplate is preferably oriented at about 45° with respect to the optical axis of the nonlinear frequency-doubling element, which will minimize noise and spurious wavelength generation within the cavity and along the output (i.e., maintaining the desired single wavelength 561 nm “yellow light” laser output). As mentioned above, the use of an optical glue to join the four components together ensures that the orientation of the waveplate with respect to the nonlinear frequency-doubling element remains fixed over time.

In accordance with the disclosed principles, an intracavity frequency doubling yellow laser is formed by providing a front cavity mirror coating (input mirror) to exhibit a high level of reflectivity (R>99.5%) at 1122 nm and 561 nm, and a high level of transmission (T>95%) at 808 nm. The rear cavity mirror (output coupler) is formed as a coating applied to the exposed endface of the fused quartz element, with the coating configured to provide for high reflection at 1122 nm (R>99.9%) and partial transmission (T>90%) at 561 nm. Beyond these basic reflective and transmissive filtering properties at the front and rear cavity mirrors, other requirements may be added to further ensure that single wavelength output of 561 nm is maintained.

A first example set of additional filtering (referred to hereafter as Example I), further requires the input mirror to include additional coatings so as to be partially transmissive for a set of defined wavelengths, with the degree of transparency T defined in terms of a percentage (with T=100% defined as complete transparency). For this Example I, the additional filter coatings are selected to provide a value of T>10% at the wavelengths of 1112 nm and 1116 nm, T>50% at the wavelength of 946 nm and T>90% for the input wavelength of 1064 nm. In this Example I set, the output mirror is also coated to be partially transmissive (T>50%) at the wavelengths of 1319 nm and 1338 nm.

A second example of additional requirements (referred to hereafter as Example II) further requires the input mirror to include additional coatings so as to be partially transmissive (T>50%) at the wavelengths of 946 nm, 1319 nm, and 1338 nm. Also used in Example II is additional coatings for the output mirror such that there is a partial transmission (T>90%) of the 1064 nm wavelength, and a partial transmission (T>10%) of the wavelengths 1112 nm and 1116 nm.

A third example of additional requirements (referred to hereafter as Example III) further requires the input mirror to include additional coatings so as to be partially transmissive (T>50%) at the wavelengths of 1319 nm and 1338 nm, with the output mirror including coatings to partially transmit (T>50%) the additional wavelength of 946 nm, and exhibit a partial transmissivity of T>90% for the input wavelength of 1064 nm. For this Example III, the input mirror includes additional coatings to provide partial transmission (T>10%) of the 1112 nm and 1116 nm wavelengths.

It is contemplated that these three different examples of additional coatings is not exhaustive; additionally, all three of these different examples may be used with the two different orderings of the elements within the resonance cavity as described above.

### BRIEF DESCRIPTION OF THE DRAWINGS

The following drawings, which are incorporated in and form a part of the specification, illustrate embodiments of the present invention and, together with the description, serve to explain the principles of the invention, where in particular:

FIG. 1 is a schematic diagram of a first example of a laser formed using the inventive principles;

FIG. 2 illustrates a response curve associated with a filter coating for the input mirror of the laser device of FIG. 1;

FIG. 3 illustrates a response curve associated with a filter coating for the output mirror of the laser device of FIG. 1;

FIG. 4 is a diagram of a second embodiment of the present disclosure;

FIG. 5 is a diagram of a third embodiments of the present disclosure;

FIG. 6 is a diagram of a fourth embodiment of the present disclosure;

FIG. 7 is a diagram of a fifth embodiment of the present disclosure; and

FIG. 8 is a diagram of a sixth embodiment of the present disclosure.

### DETAILED DESCRIPTION

FIG. 1 depicts an intracavity frequency-doubling laser device 10A-1 formed in accordance with the principles of this disclosure to provide a single wavelength output at a value of about 561 nm (that is, a “yellow light” output in the visible range). Preferably, the coatings on the input and output mirrors defining the resonance cavity are controlled such that the output exhibits a wavelength variance of ±1 nm or less.

Intracavity frequency-doubling laser device 10A-1 is shown as including a pump source 12 and a resonance cavity 14. Pump source 12 directs an input light beam at a suitable wavelength into resonance cavity 14 via an included set of coupling lenses 13. Here, for the purpose of generating laser emission at 561 nm (as a “yellow laser”), a pump beam of 808 nm is provided by pump source 12. Both pump source 12 and resonance cavity 14 may be positioned on thermo-electric cooler (TEC) elements (not shown), which are used to manage the operating temperature of laser device 10A-I so that single wavelength lasing at 561 nm is maintained.

Resonance cavity 14 is defined including a gain medium 16, a nonlinear frequency-doubling optical element 18, a birefringent waveplate 20, and a fused quartz component 22. The four components are disposed back-to-back, as shown, to form a compact, miniaturized laser structure (in contrast to prior art laser structures that utilize discrete devices as these components, with a spacing gap between each device). Resonance cavity 14 is shown and defined as extending between a front cavity mirror 24 and a rear cavity mirror 26. In accordance with the principles of this disclosure, mirrors 24 and 26 comprise a set of thin film filter coatings (formed on the endfaces of the input and output elements in resonance cavity 14) to provide the desired transmission and reflection properties required for single wavelength lasing output at 561 nm. In this example, front cavity mirror 24 is formed as a thin film filter coating on an exposed endface 16_{ef} of gain medium 16 and rear cavity mirror 26 is formed as a thin film filter coating on an exposed endface 22_{ef} of fused quartz component 22.

In one example, gain medium 16 may comprise Nd:YAG and nonlinear frequency-doubling optical element 18 may comprise KTP, with a portion of optical glue G shown as a bonding layer between facing surfaces gain medium 16 and KTP element 18. For ease of discussion, these material choices may be referenced below, but should be considered as examples only. Birefringent waveplate 20 is preferably selected to operate as a quarter wave plate for the fundamental frequency of the propagating light generated by gain medium 16 and a full-wave plate for the frequency-doubled light generated by nonlinear element 18. Waveplate 20 is oriented at a fixed angle with respect to the optical axis of nonlinear frequency-doubling optical element 18 to achieve low noise and a high polarization ratio in the output laser beam. In particular, the optical axes of waveplate 20 and frequency doubling KTP 18 are oriented at an angle of about 45°±1° with each other, where the optical axis of nonlinear frequency-doubling optical element 18 satisfied the known Class II phase matching conditions between the fundamental frequency light and the frequency doubling light. The use of portion of optical glue G to affix waveplate 20 to KTP 18 in this example ensures that the orientation between the two components remains fixed in time. Another portion of optical glue G is used join the facing surfaces of waveplate 20 and fused quartz element 22.

As mentioned above, gain medium 16 and nonlinear optical element 18 may be defined as a “first pair” of neighboring components, with birefringent waveplate 20 and fused quartz element 22 defined as a “second pair” of neighboring components, with each pair of neighboring components in contact with one another using optical glue. As mentioned above, the sequential grouping of the four components is held together by utilizing an appropriate bonding material (referred to at times as “optical glue”) that does not impact/alter the optical properties of the components (i.e., transparent to the wavelengths of interest). This affixed, back-to-back configuration of the disclosed laser results in a compact, miniaturized laser structure. As will be discussed below, gain medium 16 and nonlinear optical element 18 may exchange positions within their first pair arrangement, while the positions of waveplate 20 and fused quartz element 22 need to remain unchanged in all example embodiments.

In order to create only the yellow laser output of 561 nm, wavelength-specific coatings are added to front and rear cavity mirrors 24 and 26 to control the reflectivity/transmissivity of other wavelengths that may be created. For example, coatings that control the wavelengths of 1064 nm, 946 nm, 1319 nm, 1338 nm, 1112 nm, 1116 nm and 1122 nm may be added to front cavity mirror 24 and rear cavity mirror 26. These coatings can be arbitrarily combined in the front cavity and rear cavity mirror. A large enough loss is controlled by coating to ensure that any light propagating at the wavelengths 1064 nm, 946 nm, 1319 nm, 1338 nm, 1112 nm, and 1116 nm does not oscillate in resonance cavity 14 so as to ensure that fundamental frequency light of only 1122 nm will oscillate in the resonance cavity.

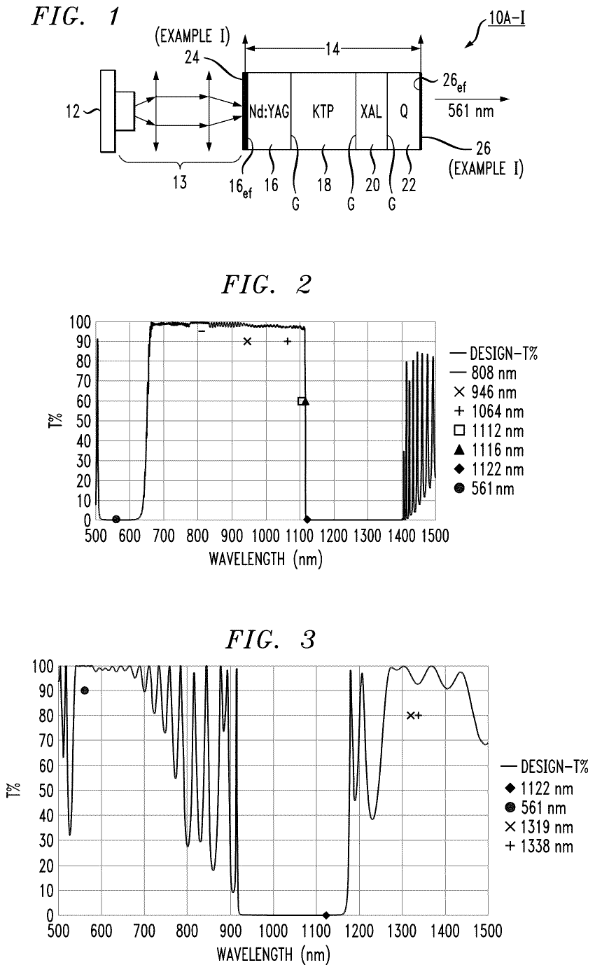

In the example of laser device 10A-1 of FIG. 1, the film coatings associated with the graphs of FIGS. 2 and 3 were used. FIG. 2 shows an example film coating for front cavity mirror 24, which is specifically coated for high reflection at 1122 nm and 561 nm (R>99.5%), high transmission at 808 nm (T>95%), partial transmission at 946 nm (T>50%), 1064 nm (T>90%), 1112 nm (T>10%) and 1116 nm (T>10%). The characteristic for a film coating of rear cavity mirror 26 is shown in FIG. 3, and exhibits high reflection at 1122 nm (R>99.9%) and partial transmission at 561 nm (T>90%), 1319 nm (T>50%) and 1338 nm (T>50%). It is an aspect of the disclosure that the inclusion of fused quartz component 22 allows for the coatings of output mirror 26 to be relatively thick and applied directly to the surface of the quartz material.

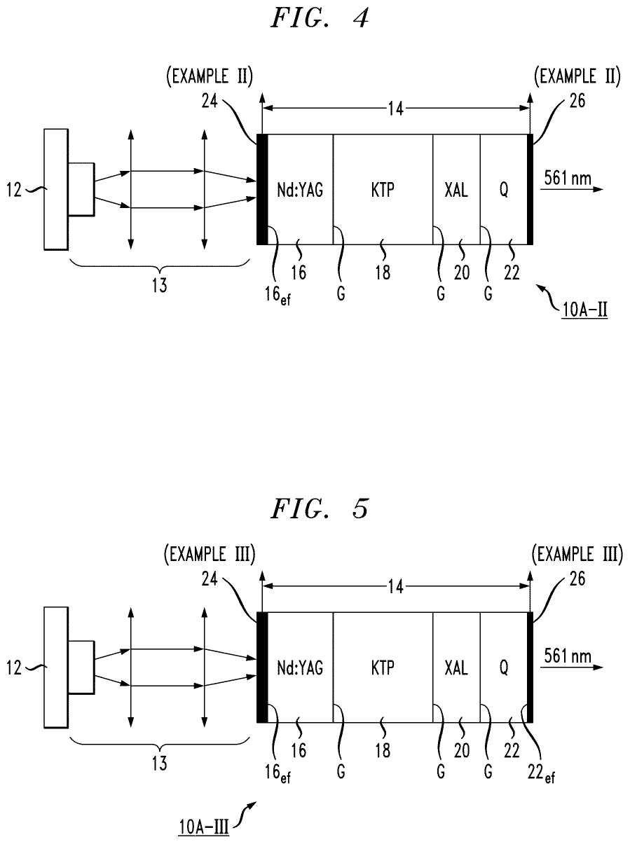

The table below summarizes these filtering conditions for the front and rear cavity mirrors for this Example I, as well as for Examples II and III described below in association with FIGS. 4 and 5.

| | FRONT CAVITY MIRROR | REAR CAVITY MIRROR |
|---|---|---|
| Example I | R > 99.5% for 561 nm, 1122 nm | R > 99.9% for 1122 nm |
| | T > 95% for 808 nm | T > 90% for 561 nm |
| | T > 90% for 1064 nm | T > 50% for 1319 nm, 1338 nm |
| | T > 50% for 946 nm | |
| | T > 10% for 1112 nm, 1116 nm | |
| Example II | R > 99.5% for 561 nm, 1122 nm | R > 99.9% for 1122 nm |
| | T > 95% for 808 nm | T > 90% for 561 nm, 1064 nm |
| | T > 50% for 946 nm, 1319 nm, | T > 10% for 1112 nm, 1116 nm |
| | 1338 nm | |
| Example III | R > 99.5% for 561 nm, 1122 nm | R > 99.9% for 1122 nm |
| | T > 95% for 808 nm | T > 90% for 561 nm, 1064 nm |
| | T > 50% for 1319, 1338 nm | T > 50% for 946 nm |
| | | T > 10% for 1112 nm, 1116 nm |

FIG. 4 illustrates another embodiment of this disclosure, in this case where the coatings for front cavity mirror 24 and rear cavity mirror 26 are associated with the Example II parameters defined above. For purposes of explanation, this embodiment is referred to as intracavity frequency-doubling yellow laser 10A-II. FIG. 5 illustrates another embodiment, using the coating parameters defined in Example III above, and is referred to as intracavity frequency-doubling yellow laser 10A-III.

As with the example of FIG. 1, a portion of optical glue G is used in the examples of FIGS. 4 and 5 to affix the individual components together that form the laser structure within resonant cavity 14.

As discussed above, an aspect of the disclosure is the utilization of fused quartz component 22 as the support for the thick filter coatings used to form rear cavity mirror 26. Thus, all embodiments of the disclosed intracavity frequency-doubling laser device require that fused quartz component 22 be positioned at the exit of resonance cavity 14, with birefringent waveplate 20 positioned immediately prior to fused quartz component 22. However, it is possible to exchange the positioning of gain medium 16 and nonlinear frequency-doubling element 18 and still generate single wavelength lasing output at 561 nm.

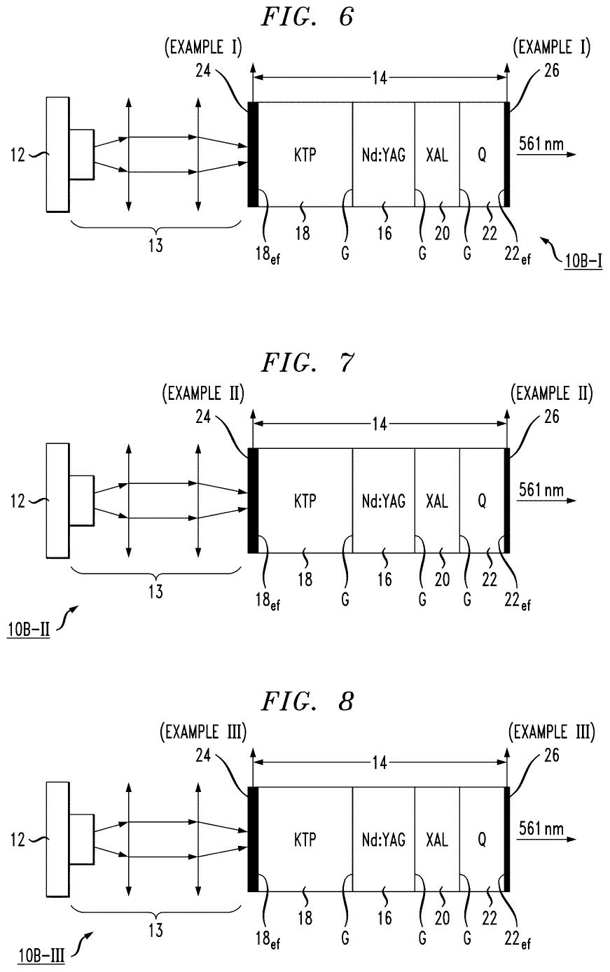

FIG. 6 illustrates an intracavity frequency-doubling yellow laser in accordance with this disclosure and referred to as laser device 10B-I, where nonlinear frequency-doubling element 18 is illustrated as disposed as the first element within resonance cavity 14, with the coatings forming front cavity mirror 24 formed on an exposed endface 18_{ef} of element 18. Gain medium 16 then positioned, as shown, between frequency-doubling element 18 and birefringent waveplate 20, with a portion of optical glue G used to affix this set of components to each other in a compact, miniaturized configuration. The use of the identified “I” in this drawing is to indicate that front cavity mirror 24 and rear cavity mirror 26 are formed as coatings that provide the filtering properties identified as Example I.

Similarly, FIG. 7 illustrates an example laser device 10B-II (using the Example II filter coatings) and FIG. 8 illustrates an example laser device 10B-III that uses the filter coatings defined as Example III. Again, an optical glue layer G is used to attach facing surfaces of these components to each other, forming the disclosed compact, miniaturized configuration.

The disclosed laser device can include one or more of the following advantages. The disclosed laser device can significantly improve the power stability of the output laser beam over temperature, which overcomes a major drawback of conventional laser devices. The disclosed laser devices are therefore suitable for a wider range of applications than the conventional laser device. The disclosed laser device can be used indoors, outdoors, and in a wide range of weather an climate conditions Furthermore, the disclosed laser device can provide output laser beams having lower noise, higher polarization ratio, and higher power than the conventional laser devices.

It should be understood that the disclosed laser device is not limited to the specific materials and configurations described above. For example, the first lasing light of the base frequency can include polarizations that are not parallel to the optical axis of the gain media. The optical axes of the nonlinear optical material and the birefringent optical material may not be exactly parallel to the direction of propagation and still yield acceptable results.

What is claimed is:

1. An intracavity frequency-doubling laser device, comprising:
a first mirror and a second, opposing mirror defining a resonance cavity therebetween;
a gain medium positioned in the resonance cavity, wherein the gain medium is configured to produce a first lasing light at a first wavelength;
a nonlinear optical component positioned in the resonance cavity, wherein the nonlinear optical component is configured to generate a second lasing light at second wavelength of about one-half the value of the first wavelength;
a birefringent waveplate positioned in the resonance cavity and oriented with respect to the nonlinear optical component to function as a quarter waveplate for the first wavelength and a full-wave plate for the second wavelength; and
a fused quartz element positioned within the resonance cavity such that the second mirror comprises a wavelength filtering coating disposed on an exit surface of the fused quartz element, the wavelength filtering coating exhibiting properties to be highly reflective at the first wavelength and partially reflective at the second wavelength such that a portion of the second lasing light passes through the fused quartz element and exits the second mirror as a frequency-doubled lasing light output of the laser device, wherein the gain medium, nonlinear optical component, birefringent waveplate and fused quartz element are disposed in an adjacent configuration with an optical glue used to affix facing surfaces to each other.

2. The intracavity frequency-doubling laser device of claim 1, wherein
the gain medium comprises Nd:YAG; and
the nonlinear optical component comprises a KTP frequency doubling crystal, the resonance cavity configured to receive a pump light input at 808 nm such that the Nd:YAG gain medium produces the first lasing light at 1122 nm and the KTP frequency-doubling crystal produces the second lasing light at 561 nm.

3. The intracavity frequency-doubling laser device of claim 2, wherein
the first mirror is defined as a front cavity mirror and comprises a wavelength filtering film having the following properties: high reflectivity of R>99.5% at the wavelengths of 1122 nm and 561 nm, and high transmissivity T>95% at the wavelength of 808 nm; and
the second mirror is defined as a rear cavity mirror and comprises a wavelength filtering film coating disposed on an exposed exit surface of the fused quartz element and having the following properties: high reflectivity of R>99.9% at the wavelength 1122 nm and partial transmission T>90% at the wavelength of 561 nm.

4. The intracavity frequency-doubling laser device of claim 3, wherein
the wavelength filtering film of the front cavity mirror is further configured to exhibit the following properties:
partially transmissive at T>90% for the wavelength of 1064 nm, partially transmissive at T>50% for the wavelength of 946 nm, and partially transmissive at T>10% for the wavelengths of 1112 nm and 1116 nm; and,
the wavelength filtering film of the rear cavity mirror is further configured to exhibit the following properties:
partially transmissive at T>50% for the wavelengths of 1319 nm and 1338 nm.

5. The intracavity frequency-doubling laser device of claim 3, wherein
the wavelength filtering film of the front cavity mirror is further configured to exhibit the following properties:
partially transmissive at T>50% for the wavelengths of 946 nm, 1319 nm and 1338 nm; and
the wavelength filtering film of the rear cavity mirror is further configured to exhibit the following properties:
partially transmissive at T>50% for the wavelength of 1064 nm and partially transmissive at T>10% for the wavelengths of 1112 nm and 1116 nm.

6. The intracavity frequency-doubling laser device of claim 3, wherein
the wavelength filtering film of the front cavity mirror is further configured to be partially transmissive at T>50% for the wavelengths of 1319 nm and 1338 nm; and
the wavelength filtering film of the rear cavity mirror is further configured to be partially transmissive at T>90% for the wavelength of 1064 nm, partially transmissive at T>50% for the wavelength of 946 nm, and partially transmissive at T>10% for the wavelengths of 1112 nm and 1116 nm.

7. The intracavity frequency-doubling laser device of claim 1, wherein the gain medium is positioned as a first component within the resonance cavity, adjacent to the first mirror, followed in order by the nonlinear optical component, the birefringent waveplate, and the fused quartz element, with a first layer of optical glue used to affix the facing surfaces of the gain medium and the nonlinear optical component, and a second layer of optical glue used to affix the facing surface of the nonlinear optical component to the birefringent waveplate.

8. The intracavity frequency-doubling device of claim 7 where in the first mirror is formed as a wavelength filtering coating on an exposed entry surface of the gain medium.

9. The intracavity frequency-doubling device of claim 7 wherein the second mirror is formed as a wavelength filtering coating on an exposed exit surface of the fused quartz element.

10. The intracavity frequency-doubling laser device of claim 1, wherein the nonlinear optical component is positioned as a first component within the resonance cavity and adjacent to the first mirror, followed in order by the gain medium, the birefringent waveplate, and the fused quartz element, with a first layer of optical glue used to affix the facing surface of the nonlinear optical component to the gain medium, and a second layer of optical glue used to affix together the facing surfaces of the gain medium and the birefringent waveplate.

11. The intracavity frequency-doubling device of claim 10 wherein the first mirror is formed as a wavelength filtering coating on an exposed entry surface of the nonlinear optical component.

12. The intracavity frequency-doubling device of claim 10 wherein the second mirror is formed as a wavelength filtering coating on an exposed exit surface of the fused quartz element.

13. An intracavity frequency-doubling laser device operating at 561 nm, comprising:
a gain medium comprising Nd:YAG;
a nonlinear optical component positioned adjacent to the gain medium, the nonlinear optical component comprising a nonlinear KTP crystal, the gain medium and the nonlinear optical component defined as a first pair of laser elements including an input face and an exit face, with a first layer of optical glue adhering together facing surfaces of the gain medium and the nonlinear optical component;
a birefringent waveplate disposed adjacent to the exit face of the first pair of laser elements and affixed thereto using a second layer of optical glue;
a fused quartz element positioned adjacent to the birefringent waveplate, the birefringent waveplate and the fused quartz element defined as a second pair of laser elements, with a third layer of optical glue adhering together facing surfaces of the birefringent waveplate and the fused quartz element, the first and second pairs of laser elements defining a laser resonance cavity, the 561 nm laser device further comprising
a front cavity mirror disposed along the input face of the first pair of laser elements, the front cavity mirror comprising a set of thin film wavelength filters selected to exhibit a high level of reflectivity at the fundamental wavelength of 1122 nm and the output laser wavelength 561 nm, and a high level of transmissivity for an input pump wavelength of 808 nm; and
a rear cavity mirror disposed along the output face of the fused quartz element, the rear cavity mirror comprising a set of thin film wavelength filters selected to exhibit a high level of transmissivity at the fundamental wavelength of 1122 nm and a high level of reflectivity at the output wavelength of 561 nm.

14. An intracavity frequency-doubling laser device operating at 561 nm as defined in claim 13, wherein the gain medium is positioned before the nonlinear optical component in the first pair of optical elements.

15. The intracavity frequency-doubling laser device operating at 561 nm as defined in claim 13, wherein the nonlinear optical component is positioned before the gain medium in the first pair of optical elements.
